(19) United States
(12) Patent Application Publication
(10) Pub. No.: US 2017/0364978 A1
(43) Pub. Date: Dec. 21, 2017

(54) METHODS AND SYSTEMS FOR REVERSE AUCTIONS AND RESOURCE POOLING FOR PERVASIVE APPLICATIONS

(71) Applicant: INTERDIGITAL TECHNOLOGY CORPORATION, Wilmington, DE (US)

(72) Inventors: Shoshana Loeb, Philadelphia, PA (US); Kuo-Chu Lee, Princeton Junction, NJ (US); Zijun Yao, North Arlington, NJ (US)

(73) Assignee: INTERDIGITAL TECHNOLOGY CORPORATION, Wilmington, DE (US)

(21) Appl. No.: 15/535,546

(22) PCT Filed: Dec. 18, 2015
(86) PCT No.: PCT/US2015/066783

§ 371 Date: Jun. 13, 2017

Related U.S. Application Data
(60) Provisional application No. 62/093,935, filed on Dec. 18, 2014.

(51) Int. Cl. G06Q 30/06; H04W 88/02; H04W 84/04

(52) U.S. Cl. CPC G06Q 30/0611; H04W 84/045; H04W 88/02

(57) ABSTRACT

Reverse auction methods and systems are disclosed herein and include fast multi-round auction methods and services to pervasive mobile applications, supporting mobile users in a location sensitive environment. A buyer agent, on behalf of a buyer, may generate a reverse auction request and then monitor auction rounds of an auction initiated based on the request. The buyer agent may terminate the reverse auction upon the auction reaching a maximal round or terminal condition, or executing an optimization policy. The optimization policy may include local optimization. The local optimization may be based on the location of a buyer and seller in a small cell network (SCN). A seller agent may calculate a bidding price based on a seller's acceptable price range and an available time window. The seller agent may determine a time to stop bidding based on bidding price rules. An auction service may select N sellers for each buyer.

### CROSS REFERENCE TO RELATED APPLICATION

This application claims the benefit of U.S. provisional application No. 62/093,935, filed Dec. 18, 2014, the content of which are hereby incorporated by reference herein.

### BACKGROUND

Multi-player games, which may use a large amount of network and server resources, are becoming increasingly popular. As the use of multi-player games increases, the strain on network and server resources may increase.

A resource contention problem may occur in multi-player games where users are engaged in rapid actions that may range from 40-400 actions per minute (APM). As the physical network and computing resources become overloaded, the quality of experience (QoE) for all users sharing the network and server resources may suffer. Further, in pervasive mobile and games application environments, users may have spontaneous needs for resources of different types under different application and environment contexts.

### SUMMARY

Reverse auction methods and systems are disclosed herein and include fast multi-round auction methods and services to support efficient parallel reverse auction services to a wide variety of pervasive mobile applications, supporting mobile users in a location sensitive and dynamic changing environment. A reverse auction method and system may be used to create a marketplace dynamically such that a user may obtain bids from multiple service providers and select a low cost provider to provide additional resources. Reverse auction mechanisms may be applied to multiple domains of applications.

Further, as disclosed herein, resource pooling and management may support fast discovery of available resources for real-time auctions. Automated agents may implement fast auction algorithms. Methods and systems disclosed herein may also control the quality of the auction by selecting winning bids based on average bid prices. Further, the methods and systems disclosed herein may support the recommendation of multiple types of compensations to promote participation.

Further, methods and systems disclosed herein may support real-time spontaneously context aware application scenarios using a reverse auction system. The reverse auction system may provide an efficient resource pooling, matching, and multi-round reverse auction process.

A buyer agent, on behalf of a buyer, may generate a reverse auction request and then monitor auction rounds of an auction initiated based on the request. The buyer agent may terminate the reverse auction upon the auction reaching a maximal round or terminal condition, or executing an optimization policy. The optimization policy may include local optimization. The local optimization may be based on the location of a buyer and seller in a small cell network (SCN).

A seller agent may select, on behalf of a seller, bidding price rules for each application and resource. The seller agent may calculate a bidding price based on a seller's acceptable price range and an available time window. The seller agent may determine a time to stop bidding based on bidding price rules.

An auction service may receive buy and sell event patterns. The event patterns may include one or more of time, location, application identification (ID), task ID, objective, context, resource ID, capacity, price and deadline. The auction service may solicit new price proposals corresponding to the event patterns from seller agents. After collecting pricing proposals, the auction service may calculate the mean, median and standard deviation of the price proposals. Further, the auction service may delete price proposals above the median and outlier price proposals. The auction service may also send a summary price to buyers and sellers. In addition, the auction service may select N sellers for each buyer and notify each buyer of the price proposals.

Further, the auction service may rank sellers based on user feedback and other criteria and invite seller to an auction based on the ranking. The auction service may also collect and track indicators of application context, user dependent criteria and a quality rating. Further, the auction service may identify resources with high availability or shortage based on the ranking of scores for each indicator. The auction service may also organize the indicators into a data cube. Further, the auction service may aggregate resource requests from a plurality of buyers into a virtual bulk request and distribute the resources obtained from the auction. The auction service may also use diverse compensation types and make recommendations to buyers and sellers.

### BRIEF DESCRIPTION OF THE DRAWINGS

A more detailed understanding may be had from the following description, given by way of example in conjunction with the accompanying drawings wherein:

FIG. 1A is a system diagram of an example communications system in which one or more disclosed embodiments may be implemented;

FIG. 1B is a system diagram of an example wireless transmit/receive unit (WTRU) that may be used within the communications system illustrated in FIG. 1A;

FIG. 1C is a system diagram of an example radio access network and an example core network that may be used within the communications system illustrated in FIG. 1A;

FIG. 1D is a diagram of an example of a small-cell backhaul in an end-to-end mobile network infrastructure;

FIG. 1E is a system diagram of an example communications system;

FIG. 2 is a system diagram of an example reverse auction service system;

FIG. 3 is a flowchart diagram of an example reverse auction algorithm;

FIG. 4 is a flowchart diagram of an example of auction resource group discovery and ranking;

FIG. 5 is a diagram of an example dashboard for real-time context aware reverse auctions;

FIG. 6 is a diagram of an example process of a reverse auction among a buyer, a seller and an auction server;

FIG. 7 is a diagram of an example process flow illustrating example request recommendations in a reverse auction; and

FIG. 8 is a diagram of an example process flow illustrating example item recommendations to buyers in a reverse auction.

### DETAILED DESCRIPTION

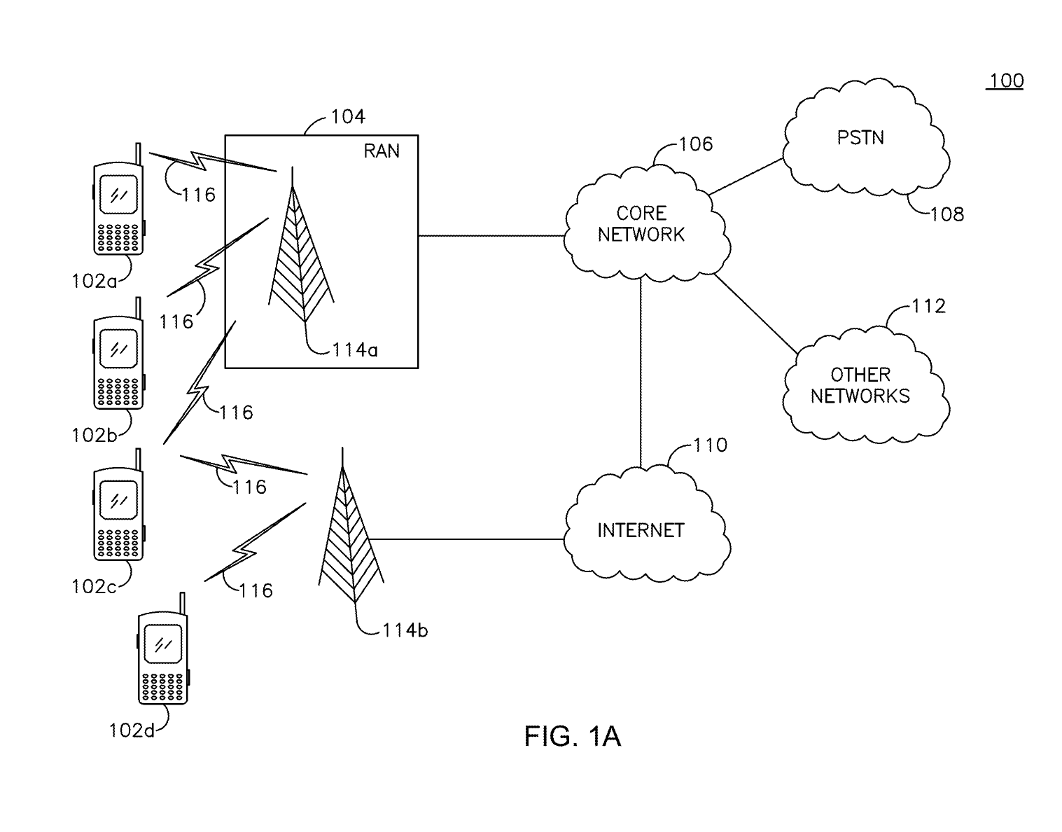

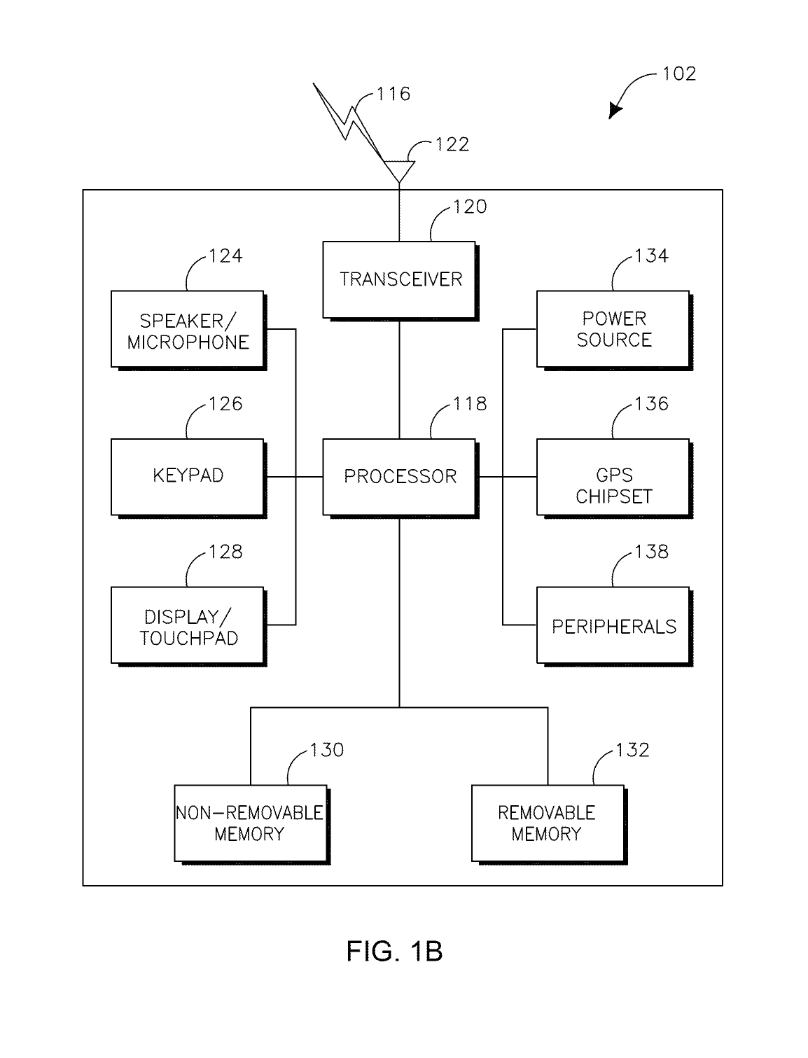

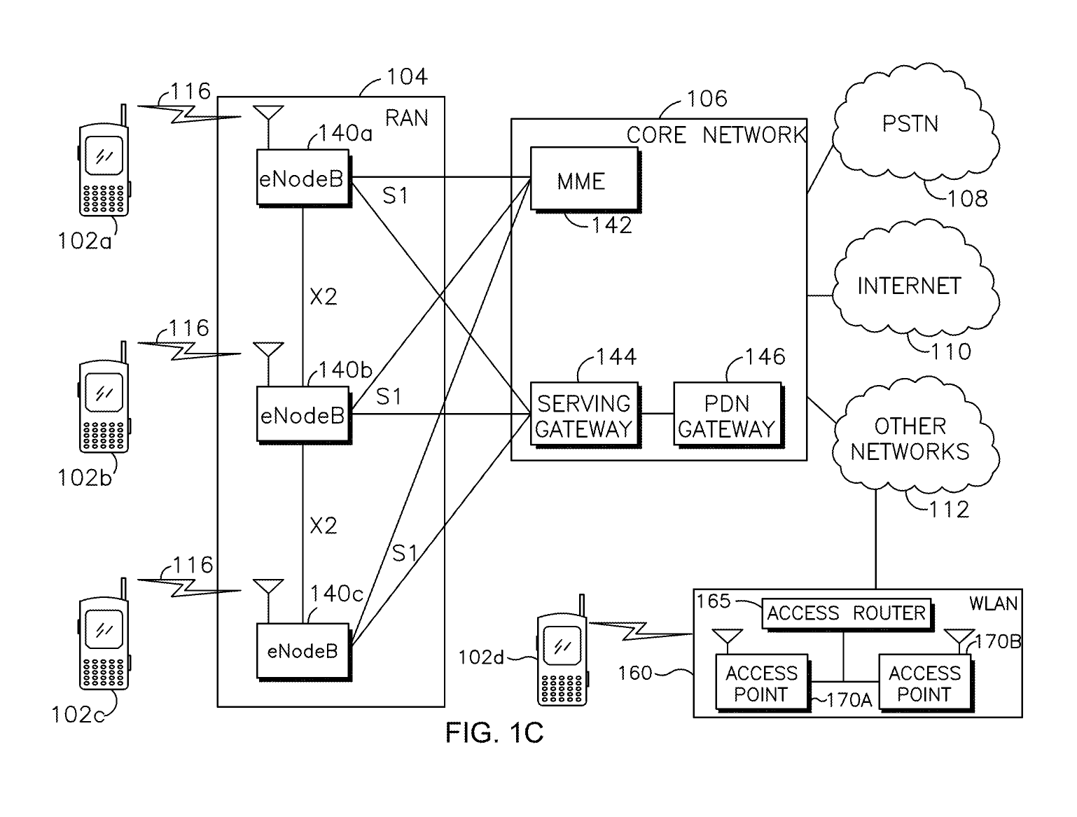

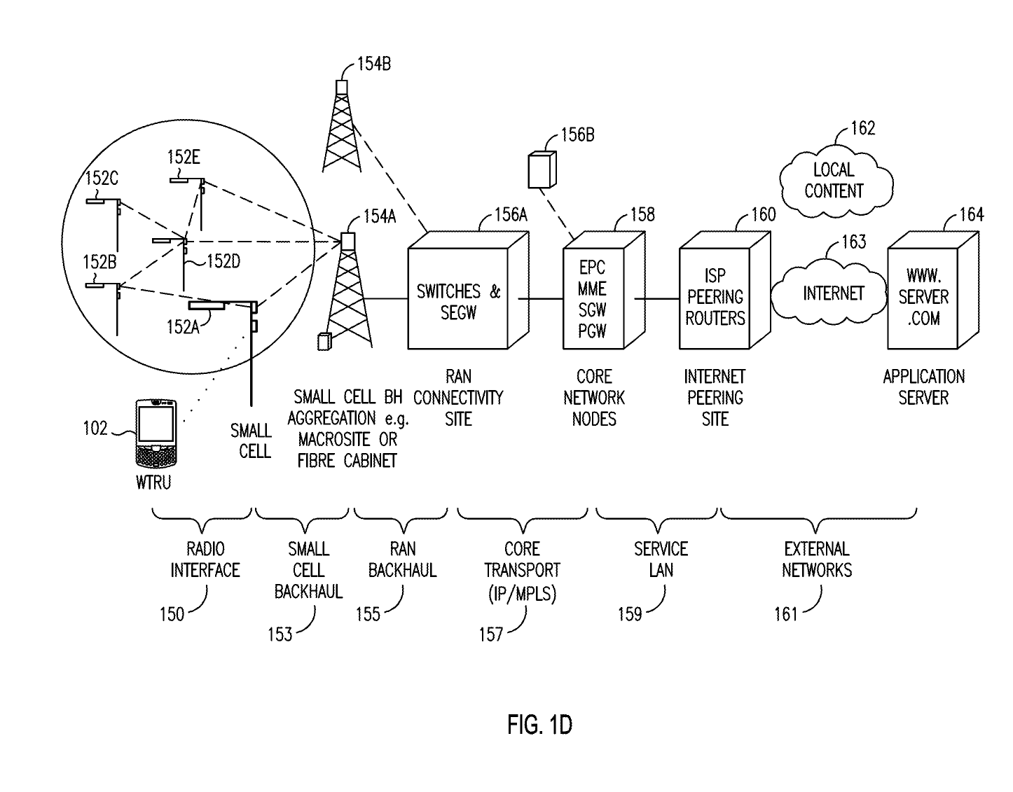

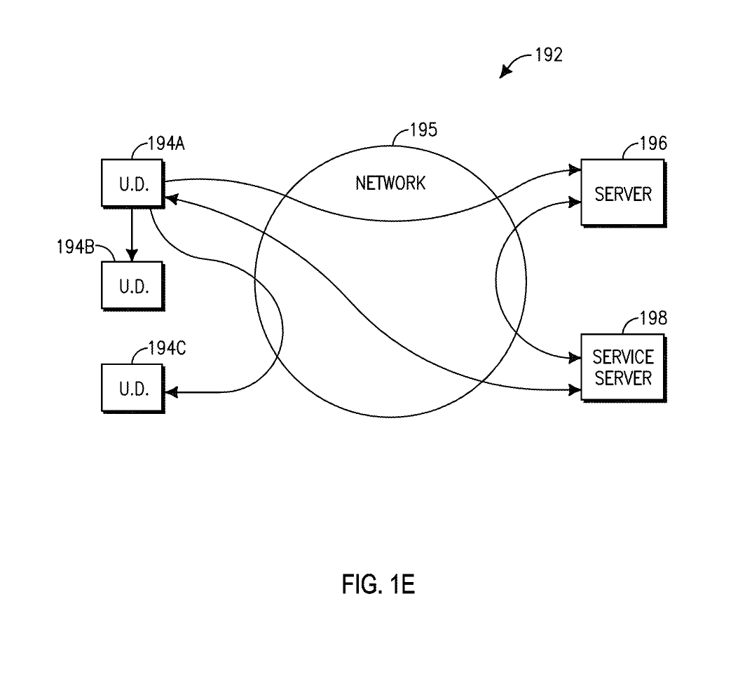

FIG. 1A is a diagram of an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 1A, the communications system 100 may include wireless transmit/receive units (WTRUs) 102a, 102b, 102c, 102d, a radio access network (RAN) 104, a core network 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communications systems 100 may also include a base station 114a and a base station 114b. Each of the base stations 114a, 114b may be any type of device configured to wirelessly interface with at least one of the WTRUs 102a, 102b, 102c, 102d to facilitate access to one or more communication networks, such as the core network 106, the Internet 110, and/or the other networks 112. By way of example, the base stations 114a, 114b may be a base transceiver station (BTS), a Node-B, an eNode B, a Home Node B, a Home eNode B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, etc. The base station 114a and/or the base station 114b may be configured to transmit and/or receive wireless signals within a particular geographic region, which may be referred to as a cell (not shown). The cell may further be divided into cell sectors. For example, the cell associated with the base station 114a may be divided into three sectors. Thus, in one embodiment, the base station 114a may include three transceivers, i.e., one for each sector of the cell. In another embodiment, the base station 114a may employ multiple-input multiple-output (MIMO) technology and, therefore, may utilize multiple transceivers for each sector of the cell.

The base stations 114a, 114b may communicate with one or more of the WTRUs 102a, 102b, 102c, 102d over an air interface 116, which may be any suitable wireless communication link (e.g., radio frequency (RF), microwave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A).

In other embodiments, the base station 114a and the WTRUs 102a, 102b, 102c may implement radio technologies such as IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, and the like. In one embodiment, the base station 114b and the WTRUs 102c, 102d may implement a radio technology such as IEEE 802.11 to establish a wireless local area network (WLAN). In another embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, etc.) to establish a picocell or femtocell. As shown in FIG. 1A, the base station 114b may have a direct connection to the Internet 110. Thus, the base station 114b may not be required to access the Internet 110 via the core network 106.

The RAN 104 may be in communication with the core network 106, which may be any type of network configured to provide voice, data, applications, and/or voice over internet protocol (VoIP) services to one or more of the WTRUs 102a, 102b, 102c, 102d. For example, the core network 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the core network 106 may be in direct or indirect communication with other RANs that employ the same RAT as the RAN 104 or a different RAT. For example, in addition to being connected to the RAN 104, which may be utilizing an E-UTRA radio technology, the core network 106 may also be in communication with another RAN (not shown) employing a GSM radio technology.

The core network 106 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include another core network connected to one or more RANs, which may employ the same RAT as the RAN 104 or a different RAT.

Some or all of the WTRUs 102a, 102b, 102c, 102d in the communications system 100 may include multi-mode capabilities, i.e., the WTRUs 102a, 102b, 102c, 102d may include multiple transceivers for communicating with different wireless networks over different wireless links. For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram of an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and other peripherals 138. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In another embodiment, the transmit/receive element 122 may be an emitter/detector configured to transmit and/or receive IR, UV, or visible light signals, for example. In yet another embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 1C is a system diagram of the RAN 104 and the core network 106 according to an embodiment. As noted above, the RAN 104 may employ an E-UTRA radio technology to communicate with the WTRUs 102a, 102b, 102c over the air interface 116. The RAN 104 may also be in communication with the core network 106.

The RAN 104 may include eNode-Bs 140a, 140b, 140c, though it will be appreciated that the RAN 104 may include any number of eNode-Bs while remaining consistent with an embodiment. The eNode-Bs 140a, 140b, 140c may each include one or more transceivers for communicating with the WTRUs 102a, 102b, 102c over the air interface 116. In one embodiment, the eNode-Bs 140a, 140b, 140c may implement MIMO technology. Thus, the eNode-B 140a, for example, may use multiple antennas to transmit wireless signals to, and receive wireless signals from, the WTRU 102a.

Each of the eNode-Bs 140a, 140b, 140c may be associated with a particular cell (not shown) and may be configured to handle radio resource management decisions, handover decisions, scheduling of users in the uplink and/or downlink, and the like. As shown in FIG. 1C, the eNode-Bs 140a, 140b, 140c may communicate with one another over an X2 interface.

The core network 106 shown in FIG. 1C may include a mobility management entity gateway (MME) 142, a serving gateway 144, and a packet data network (PDN) gateway 146. While each of the foregoing elements are depicted as part of the core network 106, it will be appreciated that any one of these elements may be owned and/or operated by an entity other than the core network operator.

The MME 142 may be connected to each of the eNode-Bs 140a, 140b, 140c in the RAN 104 via an S1 interface and may serve as a control node. For example, the MME 142 may be responsible for authenticating users of the WTRUs 102a, 102b, 102c, bearer activation/deactivation, selecting a particular serving gateway during an initial attach of the WTRUs 102a, 102b, 102c, and the like. The MME 142 may also provide a control plane function for switching between the RAN 104 and other RANs (not shown) that employ other radio technologies, such as GSM or WCDMA.

The serving gateway 144 may be connected to each of the eNode Bs 140a, 140b, 140c in the RAN 104 via the S1 interface. The serving gateway 144 may generally route and forward user data packets to/from the WTRUs 102a, 102b, 102c. The serving gateway 144 may also perform other functions, such as anchoring user planes during inter-eNode B handovers, triggering paging when downlink data is available for the WTRUs 102a, 102b, 102c, managing and storing contexts of the WTRUs 102a, 102b, 102c, and the like.

The serving gateway 144 may also be connected to the PDN gateway 146, which may provide the WTRUs 102a, 102b, 102c with access to packet-switched networks, such as the Internet 110, to facilitate communications between the WTRUs 102a, 102b, 102c and IP-enabled devices.

The core network 106 may facilitate communications with other networks. For example, the core network 106 may provide the WTRUs 102a, 102b, 102c with access to circuit-switched networks, such as the PSTN 108, to facilitate communications between the WTRUs 102a, 102b, 102c and traditional land-line communications devices. For example, the core network 106 may include, or may communicate with, an IP gateway (e.g., an IP multimedia subsystem (IMS) server) that serves as an interface between the core network 106 and the PSTN 108. In addition, the core network 106 may provide the WTRUs 102a, 102b, 102c with access to the networks 112, which may include other wired or wireless networks that are owned and/or operated by other service providers.

Other network 112 may further be connected to an IEEE 802.11 based wireless local area network (WLAN) 160. The WLAN 160 may include an access router 165. The access router 165 may contain gateway functionality. The access router 165 may be in communication with a plurality of access points (APs) 170a, 170b. The communication between access router 165 and APs 170a, 170b may be via wired Ethernet (IEEE 802.3 standards), or any type of wireless communication protocol. AP 170a may be in wireless communication over an air interface with WTRU 102d.

FIG. 1D is a diagram of an example of a small-cell backhaul in an end-to-end mobile network infrastructure. A set of small-cell nodes 152a, 152b, 152c, 152d, and 152e and aggregation points 154a and 154b interconnected via directional millimeter wave (mmW) wireless links may comprise a “directional-mesh” network and provide backhaul connectivity. For example, the WTRU 102, or multiple such WTRUs, may connect via the radio interface 150 to the small-cell backhaul 153 via small-cell 152a and aggregation point 154a. In this example, the aggregation point 154a provides the WTRU 102 access via the RAN backhaul 155 to a RAN connectivity site 156a. The WTRU 102 therefore then has access to the core network nodes 158 via the core transport 157 and to internet service provider (ISP) 180 via the service LAN 159. The WTRU also has access to external networks 181 including but not limited to local content 182, the Internet 183, and application server 184. It should be noted that for purposes of example, the number of small-cell nodes 152 is five; however, any number of nodes 152 may be included in the set of small-cell nodes.

Aggregation point 154a may include a mesh gateway node. A mesh controller 190 may be responsible for the overall mesh network formation and management. The mesh-controller 190 may be placed deep within the mobile operator's core network as it may responsible for only delay insensitive functions. In an embodiment, the data-plane traffic (user data) may not flow through the mesh-controller. The interface to the mesh-controller 190 may be only a control interface used for delay tolerant mesh configuration and management purposes. The data plane traffic may go through the serving gateway (SGW) interface of the core network nodes 158.

The aggregation point 154a, including the mesh gateway, may connect via the RAN backhaul 155 to a RAN connectivity site 156a. The aggregation point 154a, including the mesh gateway, therefore then has access to the core network nodes 158 via the core transport 157, the mesh controller 190 and to ISP 180 via the service LAN 159. The core network nodes 158 may also connect to another RAN connectivity site 156b. The aggregation point 154a, including the mesh gateway, also may connect to external networks 181 including but not limited to local content 182, the Internet 183, and application server 184.

FIG. 1E is a system diagram of an example communications system 192 in which one or more disclosed embodiments may be implemented. In some embodiments, communications system 192 may be implemented using all or a portion of system 100 as shown and described with respect to FIG. 1A.

User device 194a, server 196, and/or service server 198 may communicate over communications network 195. These communications may be wireless, wired, or any combination of wireless and wired. Communications network 195 may include the internet 110, core network 106, other networks 112, or any other suitable communications network or combination of communications networks. Communications network 195 may include a pervasive network.

User device 194a may include a WTRU (such as WTRU 102a), or any suitable user computing and/or communications device such as a desktop computer, web appliance, interactive television (ITV) device, gaming console (such as Microsoft XBOX™ or Sony Playstation™) or the like. User device 194a and/or applications executing on user device 194a may generate events such as mouse clicks, keyboard strokes, and the like. These events may be processed by user device 194a and/or may be transmitted to another device such as server 196 or service server 198. User device 194a may include a processing device and a memory. The memory may include a non-transitory computer readable medium. User device 194a may also include transmitter and/or receiver circuitry configured to communicate with other elements of system 192, or other devices, e.g., over communications network 195.

Server 196 may include a web server, application server, data server, or any combination of these or other types of servers. Server 196 may include any suitable server device such as a server computer, personal computer, or the like. Server 196 may host applications accessible to user device 196a. For example, server 196 may include a gaming server hosting a massively multiplayer online game (MMOG), an email server, a web server hosting a website such as a social media website or blog, or other types of servers typically accessible by a user device over a computer communications network. Server 196 may include a processing device and a memory. The memory may include a non-transitory computer readable medium. Server 196 may also include transmitter and/or receiver circuitry configured to communicate with other elements of system 192, or other devices, e.g., over communications network 195.

User device 194a may access server 196 over computer communications network 192 to interact with services that it provides. For example, user device 194a may access a game server hosted on server 196 to participate in a multiplayer online game. Access of server 196 by user device 194a may be via a client application executing on user device 194a or any other suitable mechanism. In some cases, the server 196 may receive events from user device 194a, or may send events to user device 194a. For example, in the context of a MMOG, the server 196 may send an event to user device 194a indicating that additional in-game resources are required for continued play. Service server 198 may include a processing device and a memory. The memory may include a non-transitory computer readable medium. Service server 198 may also include transmitter and/or receiver circuitry configured to communicate with other elements of system 192, or other devices, e.g., over communications network 195.

Service server 198 may include a web server, application server, data server, or any combination of these or other types of servers hosted on a server device. Service server 198 may include any suitable server device such as a server computer, personal computer, or the like. Service server 198 may be configured to communicate with server 196, for example, over network 195 or any other suitable communications medium. Service server may be co-located with, combined with, or in direct communication with server 196.

Service server 198 may communicate with server 196 to provide services, such as third party services, to users of server 196. For example, a subscriber to a game hosted on server 196 may access server 196 from user device 194A and may subscribe to third party services for the game which are hosted on service server 198. Administrators of server 196 may also subscribe to third party services hosted on service server 198, and may pass through or provide such services to a user of user device 194A, for example, as a white-label service or integrated with another service provided by server 196.

Service server 198 may be configured to receive and/or intercept events transmitted between user device 194a and server 196. For example, in some embodiments server 196 and service server 198 may be configured such that server 196 may send an event destined for user device 194a instead or additionally to service server 198, and service server 198 may send the event or another event, signal, or message to device 194a. For instance, in a case where server 196 includes a game server, server 196 may send an event to service server 198 indicating a requirement of a user of user device 194a, and server 198 may send the event or another signal or message to device 194a indicating that a resource is available to acquire the requirement. In some embodiments, service server 198 may only forward the event to device 194a under certain conditions, such as based on a user preference and/or context information relating to the user of device 194a.

In some embodiments, the functions of service server 198 and server 196 may be implemented using the same device, or across a number of additional devices.

In some embodiments, user devices 194b and 194c may communicate with server 196 and/or service server 198 via user device 194a. For example, user device 194a may forward a notification message from service server 198 to user device 194b via a peer to peer connection and may forward a notification message from service server 198 to user device 194c via network 195. In some embodiments, user devices 194a, 194b, and 194c may form a network, such as a peer-to-peer network, and such network may have a mesh topology, a star topology using user device 194a as a coordinating node, or any other suitable topology. In such embodiments, the peer-to-peer network may operate independently of server 196 and/or service server 198, and may incorporate functionality that otherwise would be hosted by server 196 and/or service server 198, such as functionality described herein.

Everything that follows may be, but is not required to be, employed and/or implemented using one or more, or part of one or more of the example systems discussed above.

As disclosed herein, any one of the network elements may operate in a reverse auction method and system with any one or a plurality of the WTRUs. Further, any one of the WTRUs may operate in a reverse auction method and system with any other WTRU. As disclosed herein, a reverse auction method and system may be used in a small-cell node, a group of small-cell nodes or in a wider network. However, the reverse auction method and system may be used in any wireless communication network. As disclosed herein, a reverse auction service may be referred to as a reverse auction service server and the terms may be used interchangeably.

A reverse auction method and system may be used to create a marketplace dynamically such that a user may obtain bids from multiple service providers and select a low cost provider to provide additional resources. Reverse auction mechanisms may be applied to multiple domains of applications.

Reverse auction methods and systems are disclosed herein and include fast multi-round auction methods and services to support efficient parallel reverse auction services to a wide variety of pervasive mobile applications, supporting mobile users in a location sensitive and dynamic changing environment. It is noted that pervasive networks may include or connect various personal and embedded computing devices. For example, a pervasive network may facilitate communications among internet enabled devices, such as an Internet of Things (IoT). The methods and systems disclosed herein may support fast, efficient, and/or real-time auction and management of transactions of physical and virtual resources among users and service providers. For example, traditional reverse auction processes designed for business (for example, a business to business (B2B) reverse sourcing platform or the eBuy platform used by the United States federal government) may not be suitable for the types of spontaneous automated auctions for diverse types resources requested by buyers and offered by sellers in a mobile and pervasive environment.

As disclosed herein, the reverse auction system may support various types of auction scenarios between mobile users, or other users of computer communications systems. For example, a gamer may wish to pay a price to get other heavy users off of a congested server or network. As a further example, a passenger may wish to obtain a more preferable seat or an earlier fly at low cost. In another example, a VIP player may wish to obtain the right to use of more bandwidth and CPU from other players. In a further example, a customer may wish to yield a ticket or a seat in return for rewards from other customers. In an additional example, a team may wish to invite a high-ranking player or a player with special skill (such as, for example, driving) or resource collection to overcome a temporary hardship in competition. In another example, a student may need an on-line tutoring to improve a subject area. These transactions or other types of transactions may be facilitated using reverse auction and resource pooling methods, systems, and devices as discussed further herein. It is noted that such reverse auction systems may employ a rapid reverse auction using real or virtual currency.

Methods and systems disclosed herein may include fast algorithms and service interfaces to discover and execute reverse auctions for users to obtain context sensitive resources for multiple types of pervasive applications in real-time spontaneously. The fast reverse auction algorithms may match the context (e.g., location, such as an area on a map, or situation, such as a circumstance which implies a need for a certain resource) of the buyer and seller based on available resources in order to form auction groups automatically and to select winners in real time.

Further, as disclosed herein, resource pooling and management may support the fast discovery of available resources for real-time auctions. Automated agents may implement fast auction algorithms. Also, the methods and systems disclosed herein may control the quality of the auction by selecting winning bids based on average bid prices. Further, the methods and systems disclosed herein may support the recommendation of multiple types of compensations to promote participation.

Further, methods and systems disclosed herein may support real-time spontaneously context aware application scenarios using a reverse auction system. The reverse auction system may provide an efficient resource pooling, matching, and multi-round reverse auction process.

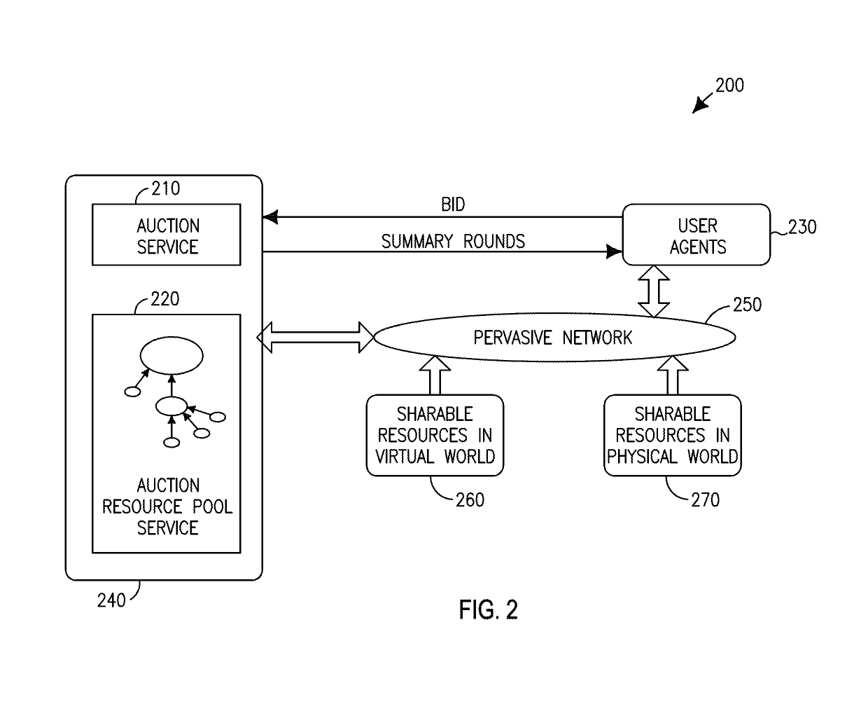

FIG. 2 is a system diagram showing an example of reverse auction service system 200 and illustrating various example components. As shown in FIG. 2, reverse auction service system 200 may include a reverse auction service 210, a resource pool service 220, and auction user agents 230. The auction service may be implemented by multiple servers, which may have open service interfaces. It is noted that in various embodiments, these services may be implemented on the same server device, or a plurality of different server devices. For example, reverse auction service 210 and resource pool service 220 may include applications executing on the same server 240, or may execute on different servers which are in communication over a suitable computer communications network.

In some implementations, auction service 210, auction resource pool service 220, and/or user agents 230 may be implemented on service server 198 as shown and described with respect to FIG. 1E. In some implementations, auction service 210, auction resource pool service 220, and/or user agents 230 may be implemented on server 196 as shown and described with respect to FIG. 1E. In some implementations, auction service 210 may be implemented on service server 198, auction resource pool service may be implemented on server 196, and user agents may be implemented both on user device 194A and 194B (e.g., buyer and seller agents respectively), for example. It is noted that any of the components of reverse auction service system 200 may also be implemented by any of the components of system 192 in any other suitable permutation.

The resource pool service 220 may support the reverse auction service 210 in a pervasive mobile environment. For example, resource pool service 220 may capture or otherwise accumulate event data or other data about resources held by or required by various users, and may associate this resource data with context information about the resources and/or corresponding users. An auction may take place at any time, and auction user agents 230 may be mobile. The auction service system 200 may facilitate auctions of resources in both the physical world (e.g., real-world goods and services) and the virtual world (for example, virtual goods and services e.g., in game and virtual reality applications).

Auction user agents 230 may participate in one or more reverse auctions. Auction user agents 230 may include both buyer user agents and seller user agents. A resource pool service 220 may provide resource subscription (e.g., registration of users or user agents for reverse auctions), status tracking (e.g., of goods or services available for sale or desired for purchase), and matching functions (e.g., cross referencing of available goods or services with desired goods or services, in some implementations based on context).

Auction resources may include items such as goods, services, network usages or resources, tickets, subscriptions, or the like. It is noted that such resources may be real or virtual. For example, auction resources may include items in the real world, or virtual items in the context of a massively multiplayer online (MMO) roleplaying game.

The resource pool service 220 may also track the location, availability and ownership of auction resources and user agents. This location may be in the real world, in a virtual world, or both. For example, resource pool service 220 may track the location of an item (or service provider, etc.) in the real world (e.g., by address or coordinates) or may track the location of a virtual item in a virtual world (e.g., by a level or map location). The resource pool service 220 may also track the availability or desirability of an item, or service, etc. (e.g., by determining whether a user's context indicates that they need an item that they lack, or that they have an item that they do not need). This tracked information may be referred to as context information. Such information may be used to identify buying opportunities to buyers or buyer agents, and/or to identify selling opportunities to sellers or seller agents.

A pervasive network 250 may provide information such as device status and sensor data communications for user agents 230, resource pooling service 220, virtual resources 260 and physical world resources 270. The pervasive network 250 may provide information such as device status and sensor data in real-time. Such device status and sensor data may be used, for example, to establish and track the user context upon which inferences are calculated about the availability, desirability, and proximity of various goods and services for an auction transaction.

On behalf of the buyer, a buyer user agent may identify the availability of various situational opportunities, or events, in reaction to which the buyer (or buyer agent) may initiate a reverse auction to acquire resources.

In this case, the buyer user agent may send a request to the auction service server 210 to create a marketplace and conduct a reverse auction, either with the buyer's affirmative consent or automatically (e.g., based on a prior configuration by the user-buyer). Then, the auction service server 210 may inspect the new auction request and search the auction resource pool 220 for available resources matching the resource request specification within a proximity of the buyer. Next, the auction service server 210 may invite owners of matched resources to participate in a new auction.

Seller user agents of invited owners may decide whether to notify the owner, who may become a seller, to participate in multiple rounds of a bidding process based on preconfigured rules. If the seller decides to accept an invitation, the seller user agent may participate in the reverse auction on behalf of the seller. It is noted that in some implementations seller agents may be configured to automatically enter a bidding process, e.g., based on preconfigured rules, without first notifying the owner. After the reverse auction is concluded, the auction service server 220 may determine a winner or winners, and may conduct the transaction of the resources and/or ownership of the resources.

In an example implementation, opportunities or events may be represented in the reverse auction service system 200 as events. Such events may include a ResourceID, a Capacity, a Price, a Location, a Time, an appID, a taskID, a Deadline and/or other descriptors. Rounds of a reverse auction may be represented using an “AuctionRound” handle, and may include a ResourceID, a RoundID, a RoundNo, a MedianOfferPrice, an ExpirationTime and/or other descriptors. Auction resource pools may be represented using an “Auction Resource Pool” handle, and may include services, goods, possessions, rights to use, ownership information, requests and/or items.

Methods and systems disclosed herein may include a common service subscription platform which may support basic functions such as user subscription, authorization, and authentication. The reverse auction service may provide additional resource pooling and matching functions. The reverse auction service may also provide resource usage information, live-ness check, and/or privacy and security protection of the resources. Resources available in the resource pool may be constantly changing, e.g., based on the changing context of users or user devices. Application programming interfaces (APIs) may be provided to search for available resources and/or to validate ownership and context of the available resources against a buyer's auction request.

Further, methods and systems disclosed herein may implement a generic multi-round auction algorithm to support fast convergence of auction rounds based, e.g., on price, context, and/or implied quality motivators. The basic form of the auction algorithm may be executed in different ways.

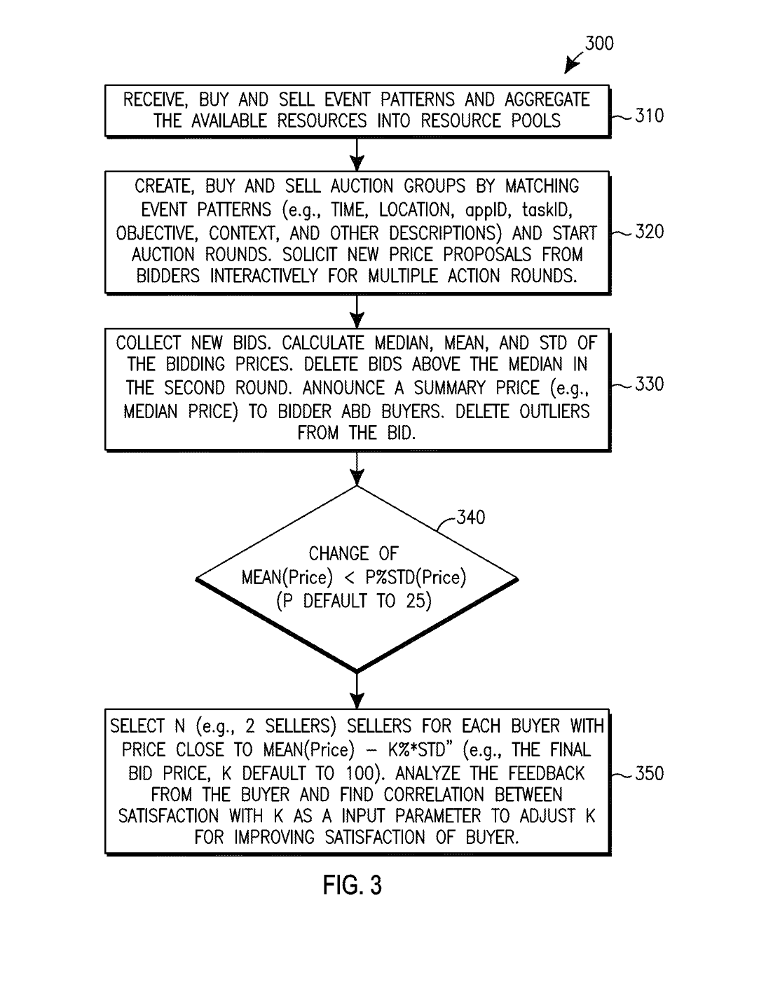

FIG. 3 is a flowchart which illustrates an example reverse auction algorithm 300 which may be implemented using reverse auction service system 200. In step 310, system 200 receives buy and sell event patterns, and aggregates the available resources into resource pools. The buy and sell event patterns may be received, for example, by auction service 210, and may be aggregated by auction resource pool service 220.

In step 320, system 200 creates buy and sell auction groups by matching event patterns. For example, system 200 may match an event indicating that a buyer has a need for an item with an event indicating that a seller has a surplus of an item. Such events may be detected, for example, via event capture and/or monitoring of context information for buyers and sellers subscribing to the auction service hosted by service server 210. Example context information may include time, location, application, task, objective, context, and/or other descriptors. After a buy and sell auction group is created, auction service server 210 may prepare to execute rounds of a reverse auction, and may solicit new proposals iteratively over each bidding round.

In step 330, the auction service server 210 may collect new bids for a bidding round, and may calculate median, mean, and standard deviation of received price bids. Auction service server 210 may delete bids above the median in each subsequent round. Service server 210 may announce a summary price (e.g., a median price of all of the received prices during the previous bidding round) to the bidder and buyers, and may delete bids that are statistical outliers.

On a condition 340 that a change in mean sell price for a new bidding round is less than P % times the standard deviation of the sell prices for the previous bidding round, the algorithm proceeds to step 350. Otherwise, the algorithm returns to step 330 to iterate for another bidding round. The value of P may be defaulted to 25 in step 340. P may indicate a threshold percentage of a standard deviation of the prices offered by sellers in each bidding round. In this example, setting P=25 would cause the algorithm (e.g., the buyer agent or service server 210 executing the algorithm) to terminate the auction (i.e., the current round will be the last bidding round before a winner or winners are determined) if the mean price offered by sellers does not change by more than 25% of the standard deviation from the previous bidding round. P may be set arbitrarily, and may be adjusted as desired (e.g., based on the type of auction).

In step 350, auction service server 210 selects N sellers for each buyer (e.g., N=2) having a price close to the difference between mean offer price and K % times the standard deviation of the offer prices. K may be defaulted to 100 initially, and may be adjusted, e.g., by the buyer or auction service provider. Service server 210 may analyze feedback from the buyer, may determine a correlation of satisfaction with K as an input parameter, and may use this correlation to adjust K to improve buyer satisfaction. For example, if K is set to select 1 standard deviation lower than the mean price, the algorithm may cause the auction to select products or services bid in the lower end of price range. If K is set to select −1 standard deviation, the algorithm may cause the auction to select seller offers bed in the higher end of the price range. If feedback is collected from the buyer, and the feedback is poor (e.g., below a certain threshold) the buyer agent or auction service may adjust K to a lower and/or negative value. Details of the various steps of algorithm 300 are discussed further below.

The auction service 210 and user agents 230 may execute auction rules using auction service APIs enforcing a policy on secure auction algorithms. For example, a buyer agent and/or seller agent may use a secure communication protocol to transmit bid and/or summary information regarding each auction round. The auction server may only release part of the summary information to the sellers. The identities of the buyers and sellers may be kept secret. Features of the auction algorithm may include the following. The auction may include a fast convergence bound. For example, the median price may be calculated in each round. Approximately half of the price range of bids may be eliminated for each round, and the median sell price may be revealed to the sellers. By revealing the median sell price, the sellers may be encouraged to submit a lower price in each later round than the announced median price.

A buyer may decide to close the bidding in any round. In an example, the detailed statistical distribution of prices may not be known to sellers. For example, the mean−K % STD may only be known to the auction engine and buyer. Mean−K % STD in this context refers to the mean price minus the percentage of the standard deviation of the offered prices of participating sellers in each round. This calculation may be used, for example, to select a group of N sellers whose offer price is approximately within a percentage of standard deviation as calculated by the auction server, while excluding sellers whose offer prices are too low or are statistical outliers having uncertain quality for real-time usage. As an example, the auction algorithm may hide the identities of the sellers from the buyers, and may hide the detailed statistical distribution of prices from the sellers. All auction steps may be performed by the seller agents automatically, based only on summary statistics received from the auction server, such as median bid price. Using the median bid price, a seller agent may automatically adjust its bid price for the next bidding round. For example, the seller agent may lower the bid price by a desired or calculated amount, unless it would reduce the bid price beyond a desired minimum set by the seller.

Some example features may address the quality of the auction. For example, an outlier bid price or prices may be deleted and may be ruled out from the computation of each round. The reverse auction system may also enforce a minimum percentage of transaction fees as revenue to the auction service. The reverse auction system 200 may select for a lower than average selling price, e.g., by a fixed standard deviation. The reverse auction system 200 may track below-average bidding prices over multiple auctions and may track and determine a trend in the market price for each type of auction resource. The reverse auction system 200 may also discourage abnormally low bids and may enforce a minimum percentage of transaction fees for the auction service. In an example, by adjusting a convergence parameter, K, the reverse auction system 200 may pick the lowest bid as an option for specific types of resources (such as, for example, yielding a seat for a senior citizen or other non-profit addition to the auction service).

As a further example feature, the reverse auction system 200 may track the behaviors of the sellers and buyers who withdraw from the auctions either during the auction or after the auction is completed. The parties who withdraw from the auction may be given lower participation ratings.

As another example feature, incentive controls may be realized by adjusting the parameter K. For example, reverse auction system 200 may set a small K to pick bidders offering the average price. The reverse auction system 200 may set a large K to pick bidders offering deep discounts.

As yet a further example feature, the reverse auction system 200 may collect feedback on auctioned items and may analyze the correlation between the price and satisfaction based on the feedback. This correlation may be part of the parameter used for adjusting the K factor.

Further, example features of the reverse auction system 200 may include opportunity discovery and promotion. For example, in addition to pooling the resources for auction, the reverse auction system 200 may analyze the resources specified in the auction requests and auction transactions, and may recommend auction opportunities to buyers and sellers.

The reverse auction system 200 may also support fast resource ownership exchange based on context information collected and tracked in the resource pool. The time duration of resource availability and resource usage may be used as context information to determine the value of the resource to a spontaneous buyer. In addition to the time availability and usage of resources (i.e., temporal and spatial context), aspects of the buyer's interaction with an application (i.e., application context), such as whether the user is playing a game, having difficulties solving a problem, has an urgent home repair need, or needs a ride to hospital, may also be used as context information to determine the value of a resource.

For example, if a player encounters an obstacle in playing a new game, context information may include the type of game and specific in-game task that the player is executing. The player/buyer may also specify whether the auction is urgent or not as an option. The seller may adjust the bid accordingly. The temporal spatial and application contexts may be set as part of the resource properties that may be adjusted by buyers and sellers dynamically to select participants. The context information may prompt a reverse auction which may take place automatically at any suitable place and/or any suitable time based on the context, and may prompt a mobile user to start a reverse auction.

The following data model may be used to describe context information which may be used by the seller's agent, the buyer's agent, the resource pool service, and the auction service. The data model may include an auction request, a bid from a seller for each round and statistics for each round (RoundStats).

An auction request may include the following:

```
{
AuctionGroupID | Token, //Unique bidding group identifier or Token
BuyerID, //Buyer identifier
Location: [Latitude, Longitude],
AppName, [Food | Costume | HomeRepair | Ride | Subscription |
        Ticket].
ResourceName, [Coaching.[PuzzleHint | Golf lecture | FitnessLesson]
            | Ride.[mile | time | person | destination] |
            Subscription.[Wifi | GameServer | Movie ] |
            FastFood.[Pizza, Chinese, TurkeySandwich] |
            HomeRepair.[Furnace | Heater | Washer]
ResourceDescription, [Pizza.[Cheese | Broccoli | Meat ] |
                Ride.[Urgency | Type of car preferred ] |
                Furnace.[Maintenance | BrandName.[Parts]] |
                Wifi.[usage] | GameServer [usage]
ResourceUsageOrItemDeliveryTimeWindow[ ],
RightToUseDuration, [Wifi. [30 minutes | 1 hour | 2 hours day ]
AuctionCompensationOptions, //Resource as alternative compensation
                    instead of currency based price.
}
```

In this example, the auction request, which may be input to the auction service 210 by a buyer user agent, provides an identifier for the bidding group (AuctionGroupID), an identifier for the buyer (BuyerID), a representation of the buyer's location (Location), a name of applications relevant to the auction request (AppName), a description of the resources required by the buyer (ResourceName), a delivery window within which the purchased resources are required by the buyer (ResourceUsageOrItemDeliveryTimeWindow), a duration which one of the requested resources (in this case, Wifi) is required to be used by the buyer (RightToUseDuration), and options for payment by the user, such as a currency, type of currency, or goods for barter, for example (AuctionCompensationOption). It is noted that the auction request may include some or all of these fields, or may alternatively or additionally include other fields.

A bid from a seller for each round may include the following.

{
AuctionGroupID | Token , //Unique bidding group ID or Token for the
auction

| | |
|---|---|
| SellerID, | //Seller ID |
| {[Price, RndNo]}, | // List of price for each round, |

```
Location: [Latitude, Longitude]
AppName, [Fast food | Costume for rent | Home repair | Ride |
        MembershipSubscription | Concert ticket].
ResourceName, [Coaching.[PuzzleHint | Golf lecture | FitnessLesson]
            | Ride.[mile | time | person ] | Subscription.[Wifi |
            GameServer | Movie ] | FastFood.[Pizza, Chinese,
            TurkeySandwish] | HomeRepair.[Furnace | Heater |
            Washer] |
ResourceOwnerID, [Company-ID | Store-ID | User-ID | Product-ID |
            Service-ID, Ticket-ID
ResourceDescription, [Pizza.[Cheese | Broccoli | Meat ] |
                Furnace.[Maintenance | BrandName.[Parts]] |
                Wifi.[usage] | GameServer [usage]
LatestAcceptableDelivery,
RightToUseDuration, [Wifi.[30 minutes | 1 hour] | GameServer.[1hr |
2 hr]
AuctionCompensationOptions, //Resource as alternative compensation
                    instead of currency based price.
}
```

In this example, the bid, which may be input to the auction service 210 by a seller user agent, provides an identifier for the bidding group (AuctionGroupID), an identifier for the seller (SellerID), a representation of the price bid by the seller for a particular round of bidding ({[Price, RndNo]}, a representation of the seller's location (Location), a name of applications relevant to the bid (AppName), an identifier of the resources bid for sale by the seller (ResourceName), A description of the owner of the resources (ResourceOwnerID), a description of the resources bid for sale by the seller (ResourceDescription), a delivery time after which the resources bid for sale are no longer available for delivery (LatestAcceptableDelivery), a duration which particular requested resources (in this case, Wifi, GameServer) are available to be used by the buyer (RightToUseDuration), and options for payment by the user, such as a currency, type of currency, or goods for barter, for example (AuctionCompensationOption). It is noted that the bid may include some or all of these fields, or may alternatively or additionally include other fields.

Statistics for each auction round (RoundStats) may include the following.

RoundStats // Announcement of bid summary for each round to
participants. The stats are delivered to seller such that the seller
auction agent may adjust offer price lower for each round interactively.
{
AuctionGroupID | Token, //Unique biding group ID or token
{[MedianPrice, RndNo]}, // Median price of each round,
MedianEarliestAvailableTime,
MedianRightToUseDuration,
OtherAppSpecificContextList
}

In this example, the statistics, which may be output from to the auction service 210 to one or more seller user agents participating in the auction, provides an identifier for the bidding group (AuctionGroupID), a representation of the median price bid by the sellers for a particular round of bidding ({[MedianPrice, RndNo]}, a median earliest time that resources offered by the sellers are available (MedianEarliestAvailableTime), the median duration which resources offered by the sellers are available to be used by the buyer (MedianRightToUseDuration), and other information (OtherAppSpecificContextList). It is noted that the round statistics may include some or all of these fields, or may alternatively or additionally include other fields.

A buyer agent may serve a number of functions within a reverse auction service such as reverse auction service system 200. Various example functions are provided herein, and a buyer agent may provide some or all of these functions, and/or other functions. Example functions of the buyer agent may include subscribing to the auction service 210, detecting resource conditions (e.g., determining whether the buyer needs certain resources based on the buyer's user context), and generating auction requests (e.g., to auction service 210) in order to obtain necessary resources at a low cost. The buyer agent may detect events from one or more applications (e.g., running on the buyer's user device) which may indicate that the user requires one or more additional resources. For example, the user may lack sufficient network bandwidth for lag-free play of an online game, may encounter problems when playing a puzzle game from a mobile game application, or may exhibit performance indicating a need to find a coach to learn a new skill from a fitness application. Also or alternatively, the buyer may affirmatively request such resources.

Example buyer agent functions may include inputting parameters from the buyer, initiating auction requests and monitoring the iterative bidding rounds, and/or outputting parameters to the buyer. Example parameters which may be input from the buyer to the buyer agent may include subscribing to auction services (e.g., auction service 210) and registering resources which may be of interest to purchase; an acceptable price range [max, 0] for the resources of interest; a required available time window [Tstart, Tend]; inserting an auction optimization policy (for example, configuring the auction service 210 (e.g., via the auction request) to optimize response time based on location); and/or insertion of auction termination criteria (e.g., a maximum number of rounds and/or a lowest average bid threshold, K).

Further example buyer agent functions may include initiating auction requests and monitoring the iterative bidding rounds. These example functions may include monitoring usage of resources and detecting conditions under which to initiate auctions (e.g., undesirable levels of resource depletion, etc.); generating an auction request to acquire a resource, which may be identified with resource identification (ID); monitoring rounds of the requested auction; terminating the auction if a desired maximum number of rounds have been executed; and/or terminating the auction if a termination condition is reached.

Other example buyer agent functions may include executing one or more optimization policies. For example, a buyer agent may apply a location optimization to the bidding process. To optimize for location, the buyer agent may obtain more than one seller offer from the auction service 210. The buyer agent may rank the offers based on location (e.g., the buyer agent may weight offers from sellers located closest to the buyer or to the place the resource will be utilized more favorably in selecting a winning bid).

A buyer agent may also apply a time-of-availability optimization to the bidding process. To optimize for time-of-availability, the buyer agent may obtain more than one seller offer from the auction service 210. The buyer agent may rank these offers based on when they will be available to the buyer or when they will be available at a location where they are required. For example, the buyer agent or may weight an offer that would be made available immediately more favorably in determining a winning bid.

Another example buyer agent function includes monitoring whether a winner or seller withdraws from the bidding process. This function may be relevant in auction scenarios where seller resources may become unavailable or move out of the area where they are required. This may lead to cases where the seller may not be able to complete the auction. This function may also be relevant in auction scenarios where sellers are permitted to change their minds, or where sellers input low bids and/or drop off bidding frequently. In such cases, the sellers may drop out of the auction automatically or manually after a few rounds of bids. The buyer agent may thus automatically delete these sellers' offers when informed by the auction service.

Examples of functions of the buyer agent which provide output parameters to the buyer may include reporting the auction announcement to buyer; reporting auction results to the buyer; confirming policies specified by the buyer; providing a ranked resource list based on time and location or other context from which the buyer may choose, and confirm; and/or informing the buyer the seller's identity if the auction is not an anonymous auction. It is noted that in some implementations if the buyer (or buyer agent) decides that none of the offers are satisfactory, the buyer (or buyer agent) may decide to refuse all the offers. In this case, the buyer agent may interact with the auction service to cancel the auction.

A seller agent may serve a number of functions within a reverse auction service such as reverse auction service system 200. Various example functions are provided herein, and a seller agent may provide some or all of these functions, and/or other functions. Example functions of the seller agent may include participating in automated reverse auctions (e.g., facilitated by auction service 210) based on seller provided auction control parameters. Other example functions may include, inputting parameters from the seller; selecting bidding price setting rules for each of (or a subset of) the seller's applications and resources; and/or outputting one or more parameters to the seller.

Example parameters which may be input to the seller agent, e.g., from the seller, may include instructions to subscribe to an auction service (e.g., auction service 210) and to register available resources for auctions facilitated by the auction service; granting auction invitation requests (e.g., from auction service 210); acceptable bidding price ranges [maxPrice, minPrice]; and available time windows [Tstart, Tend].

Selecting bidding price setting rules for each application and resource may include participating in the bidding rounds using bidding rules. The bidding rules may be based on price limits set by the seller and/or a median price for each bidding round announced by the auction service. The bidding price setting rules may be used by the seller agent to make various decisions which may include when to stop and when to continue participating in an auction; and/or how to calculate a bidding price, e.g., based on price range and available time window. An example bidding price calculation rule may include, for example, to insert a decreasing bid (BidPrice), which may equal a minimum price (minPrice)+(50%) (Announced Median Price from last round−minPrice) where BidPrice<a desired maximum price (maxPrice)).

Example output parameters, which may be output from the seller agent to the seller, may include auction invitation notices. Such invitation notices may include necessary information about resource requests, auction IDs, and the like. Other example output parameters may include median prices (e.g., MedianPriceList) for each bidding round; and/or reverse auction results. Reverse auction results may include, for example, an indication of whether the reverse auction was won or lost by the seller agent, and/or a price range across all winning sellers having resources qualified for the buyer.

An auction service (e.g., auction service 210) may implement one or more optimization policies. The auction service may, for example, support policy rules predicated on context information collected by the resource pool from user agents (e.g. user agents 230) of buyers and sellers. The auction service may support context aware optimization policies including options to select groups of participants. Example optimization policies may include maximizing a resource utilization time window; and minimizing a location and/or time difference between a buyer and seller.

In order to maximize a resource utilization time window, the auction service may select a seller having a maximum overlap between the time window that the resource is available from the seller or seller agent and the usage window requested by the buyer or buyer agent. This may have the benefit of optimizing resource usage of available auction resources.

In order to minimize location and/or time differences between buyers and sellers, location and time information may be combined to select qualified sellers and buyers in the proximity (in time and/or space) of the buyer to the seller, or between where the goods or services are needed and where they will be available. This may have the benefit of reducing resource availability response time for time sensitive location based applications.

Methods and systems disclosed herein may also include time and location sensitive resource discovery and pooling, and may support fast spontaneous auction processes. For example, auction resource pool service 220 may achieve fast and automated auction fulfillment by implementing discovery and optimized resource matching rules. Such matching rules may be implemented to detect events sent from buyers, sellers, and resources. The seller may be the entity that holds responsibility to register auction resources (one or more) and to fulfill the auction transactions. The seller agent may conduct an auction on behalf of the seller. Sellers may include companies having many resources or individuals having fewer resources, for example. Matching discovery rules may perform several operations, examples of which may include the following.

Matching discovery rules may be implemented by a reverse auction system, such as system 200. In particular, matching discovery rules may be implemented by an auction resource pool service, such as service 220. Such matching discovery rules may be implemented to collect events from or regarding virtual and/or physical resources. Such events may be captured via a pervasive network (such as network 250) and may be captured in real-time or near-real-time. Captured events may be tagged with application related context information. Various examples of such context information tags are as follows:

{App_ID, App_Session, {ResourceType, ResourceUsage,
AvailableCapacity}, {ServiceType, ServiceAlertIndicator,
RequiredServiceLevel}, {Geo-location}, TimeStamp, other support
data ...}

Such context tags may represent, respectively, an identifier for a relevant app or app session, a type of the resource, usage of the resource, and available capacity of the resource, a type of a service, an alert indicator for the service, a required service level, a geographical location, a current time, or any other suitable context information.

In an illustrative example, a reverse auction for a road-assistance application, either in the real-world or in a virtual reality world, for a driver with a flat tire or bad battery, may be supported by the following resource or service models:

```
{
  AppID: SmartCar-IDxyz, Session: “Maintenance”,
  {ResourceType: “Tire”, ResourceUsage: “100%”, AvailCapacity: “0%”},
  {ServiceType: “Tire”, ServiceAlertIndicator: “0% PSI”, AvailService:
  “0% ”},
  Or
  {ResourceType: “Battery”, ResourceUsage: “100%”, AvailCapacity:
  “0%”},
  {ServiceType: “Charge Battery”, ServiceAlertIndicator: “95%”,
  AvailableForService: “0% ”},
  {Geo-location: [77.3456, 88.5909]},
  TimeStamp: “12-12-2014 17:30:23”, other support data ...
}
```

Here, the context information includes identifiers for app and session. A resource type for the tire is configured indicating 100% usage, but 0% available capacity. A service type for the tire is configured as “Tire” (meaning that the tire should be replaced or repaired in this context on an alert condition) with a service alert indicator for the tire set to 0% of a nominal tire pressure, and a service availability of the tire is configured at 0%. A resource type for the battery is configured indicating 100% usage, but 0% available capacity. A service type for the battery is configured as “Charge Battery” (meaning that the battery should be charged in this context on an alert condition) with a service alert indicator for the battery set to 95% of a nominal charge, and a service availability of the battery is configured at 0%. Further, a geographic location of these resources may be provided as a timestamp for the data.

Matching discovery rules may, for example, extract, track, and/or predict {ResourceUsage, ServiceAlertIndicator} and may detect whether there is a “resource shortage” or “service alert” or both. For example, the above road assistance application may implement the following detection rule:

```
If
  AvailCapacity or AvailableForService < 2% (or a few std below
  normal level)
Then,
  Perform fast proximity search and predict the best matches for
  nearby resources (Cars) or auto-shops:
      Distance(buyer, sellers) < 2 miles
  And
  AvailCapacity or AvailableForService > 90%
```

Here, on a condition that an available capacity or service availability of the resource is below a threshold, sellers offering remediation measures (in this case, other smart cars or repair shops) are located which are within a threshold proximity to the resource (and by extension the buyer) and which have an available capacity or service availability above a certain threshold.

In this example, the matching discovery rules may be implemented to invite user agents (i.e., seller agents) for the owners of other smart cars or repair shops to participate in a new auction. Further, the matching discovery rules may be implemented to execute the reverse auction (e.g., automatically) and to assign the selected winner of the auction to perform the service.

Upon completion of the auction, matching discovery rules may be effected to perform transactions to fulfill the auction payment and to collect feedback information. For example, a buyer agent may implement linking of auction fulfillment processes with a user profile (e.g., preference, calendar, and detailed maintenance records).

A resource pooling service (e.g., auction resource pool service 220) may be rule-based and may support many different kinds of applications. For applications constrained by a temporal and context relationship, finding participants that are most likely to offer the resource or service in time may be of interest. As a result, it may be desirable for the auction process to continually seek auction candidates and to rank potential candidates that may provide value to potential auctions.

To improve the efficiency of such continuous auction candidate discovery and identification processes, the auction service 210 may implement an advanced auction candidate ranking method. Examples of such a method are described in the following.

To support a continuous evolving auction candidate ranking operation, the auction process may first define common data models for an auction participant resource tracking and ranking operation. The resource pool (e.g., auction resource pool service 220) may group the application context into a structure, which may be denoted as a context set, C. The resource pool may also group the behavior of resources or services that require additional user dependent criteria, such as an available schedule, performance or skill level, of a live coach or highly ranked players, as user behavior set, B. Quality rankings or qualification certificates of game players or technicians may be modeled as part of a quality assessment descriptor set, Q.

The reverse auction service (e.g., auction service 210) may manage seller quality ranking based on user feedback, auction participation records, and/or application specific quality statements provided by the seller. User feedback may provide information on the quality of resources provided by the seller based on user reviews of the resources. Another application-independent quality indicator for sellers may include the number of bid withdrawals during the auction, or failures to fulfill auctioned resources. In addition, each application may provide a quality ranking statement in a quality descriptor for review by the buyer. For example, for auto-repair or plumbing work, the seller may provide professional certificates or other customer review survey information from a reputable source (such as, for example, a website or other public sources) in the descriptor.

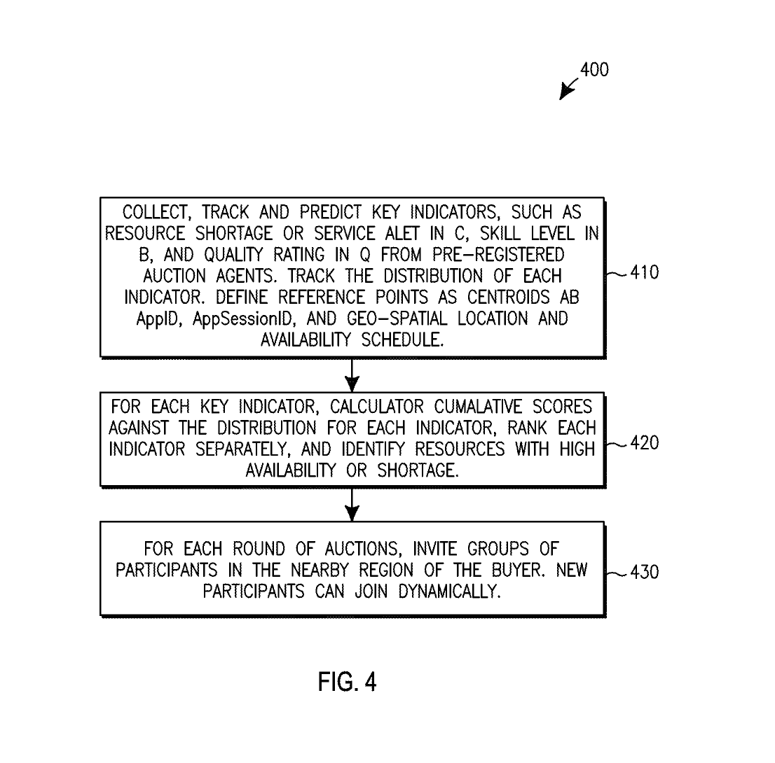

FIG. 4 is a flowchart diagram which illustrates an example auction resource group discovery and ranking method 400. In step 410, auction resource pool service 220 may collect, track, and predict indicators in a data cube for pre-registered auction agents. For example, resource shortages or service alerts may be stored in the data cube in a context set C, skill levels may be stored in the cube in a behavior set B, and quality ratings may be stored in the cube in a quality set Q. The distribution of each indicator may be tracked using parameters such as application ID, application session ID, geo-spatial location, and/or availability.

In step 420, the resource pool service 220 may calculate cumulative scores against the distribution for some or all of the indicators. In an example, a cumulative score may be a weekly average percentile ranking of daily percentile rankings of resource usage, skill level and/or changes in quality rating feedback. It is noted that various types of such cumulative scores are possible. Each indicator may be ranked separately, and resources with a high (e.g., above a certain threshold) availability or scarcity may be identified.

In step 430, for each round of an auction, the resource pool service 220 may invite groups of participants within a certain proximity of the buyer to join in the bidding dynamically.

To organize the resources for each auction, the resource pool service 220 may use a data cube to store the statistics of parameters in the sets, C, B, and Q. As an example implementation of the algorithm in FIG. 4, the algorithm may rank the resources and store the rank in the data cube to support fast auction group participant search operations by the auction engines. The selected participants may be invited to join the bidding rounds.

The generic multi-dimensional grouping method, resource discovery, and auction service may be used as a common platform service for multiple applications by mapping the context representation into the C, B, and Q sets and by using the same participant discovery, ranking and auction group generation process for each application. For example, a location sensitive ticket trading auction application may implement the auction service. In this scenario, audience members may reverse auction a ticket before a show or exchange a seat during the show. In this case, C may be a descriptor for a ticket resale and seat assignment exchange mobile application, with resource indicators in a dashboard to display available tickets for sale or alternative seats obtained from automated auctions as options for the user to select. The behavior set B may be used to match a schedule. For tickets sold before the show, the time during which the ticket is available for resale may be specified before the show. In an example scenario, an audience member having a hearing or vision problem may realize that it is necessary to change to a seat closer to the stage. Audience members who may not remain interested through the whole seminar or show may make the seat available after the intermission. In this case, the availability of seats of audience members may be modeled in B.

A more complex case may involve additional qualification descriptors, such as a skill assessment of a person or a quality assessment of an auction object (for example, antique or fashion items). For example, if an audience member needs to hire a good student who attended a similar seminar to assist with a subject or to help correct a golf playing skill, the skill level of potential candidates (for example, honor rolls, reputable school graduation, or game play ranking) may be used as input for Q. If a person needs to rent an evening gown, the style and size range may likewise be specified in Q. In an example, the resource discovery, ranking and grouping service may keep all of the information anonymous and up to date to protect privacy and maintain service quality.

The auction resource pool service 220 may support efficient resource auctions in bulk. For example, the auction resource pool service 220 may support buyer demand aggregation. The resource pooling service may aggregate resource usage requests from a plurality of buyers to solicit bids from sellers for volume discounts. In an example scenario, the auction service may not find the seller with a minimum quantity matching the buyer request. The resource pool may then collect multiple requests to form a “virtual” bulk buyer. The resources obtained from bulk sellers may later be distributed to multiple buyers. Sellers may participate in a bulk auction and obtain a list of the shipping addresses from the reverse auction service. In some implementations, the auction service provider may provide warehousing, allocation and distribution services to unbundle the resources to multiple buyers.

As a further example, the auction resource pool service 220 may support seller resource aggregation. The auction resource pool service 220 may aggregate resources available from multiple sellers to meet the demand of a larger buyer. The auction resource pool service 220 may collect resources from multiple winning bidders and may group them into one resource to deliver to the buyer. In an example, commissions and differences in bulk auctions may be shared between an auction service provider and buyers.

The reverse auction service 210 may include a real-time dashboard for an automated auction. When supporting multiple types of resource auctions for multiple applications, it may be inconvenient for a user to switch to different applications and activate separate auction service requests. In an example, the reverse auction service 210 may make available a pervasive unified resource auction dashboard. The dashboard may provide a number of possible features. For example, the dashboard may display auction opportunities. Based on the context of the buyer and past auction history, the dashboard may display auction resources that are most relevant to the context of the activities that the buyer is engaging in. The dashboard may also or alternatively display auction status and results. A summary of current and past auction resources and prices may be displayed in temporal order and may be aligned with a calendar service, for example.

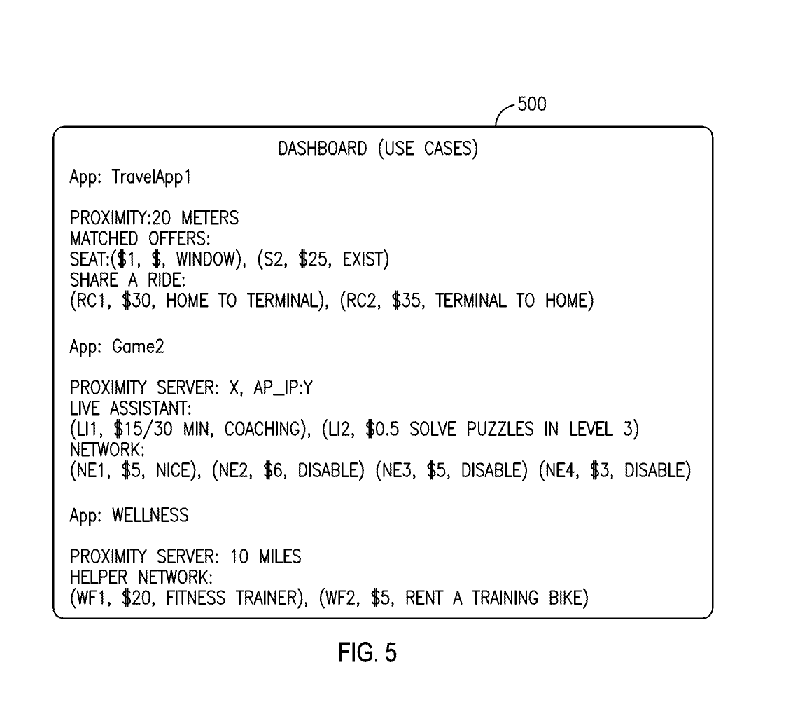

FIG. 5 is a diagram of an example dashboard 500 for context aware reverse auctions. The following example dashboard operation scenario illustrates a pervasive unified reverse auction service for a user who may allocate resources based on travel schedule and activities. The dashboard may display multiple types of resources the user acquired using the reverse auction service.

In the example of FIG. 5, a buyer, either explicitly, or implicitly based on context, indicates a need to book a flight using a travel application. Based on an automated reverse auction process such as described herein, the buyer receives an offer for window seat for $20 and EXIT row for $25. Based on context, the buyer also receives an offer for a ride to airport for $30 and ride home for $35. In the airport lounge, the user plays a virtual golf game, and receives offers to hire a live coach to learn how to play the game and identify gesture problems for $15, and an offer to hire an agent to solve a difficult puzzle for $0.50 on the plane. When the buyer experiences network problems in the plane, based on context, the buyer receives offers from four network users to log out of the busy network for a cost ranging from $3 to $6. After arrival at the hotel, the user receives an offer to hire a $20/30 min trainer, who happened to have just finished a fitness class (i.e., is available based on temporal context) and to share a remaining lease of rental bike from a previous session (i.e., is available based on temporal context) with the user at a discounted price of $5.

Thus, the dashboard may aggregate information relating to various reverse auction results across a variety of applications for the user to conveniently manage. It is noted that as discussed further herein, the reverse auctions in this example may have taken place automatically, e.g., as facilitated by a buyer agent hosted on a third party service server, which tracks the user's context.

For example, the buyer agent may track the buyer's schedule to determine the need for airline tickets, and may track the user's travel history to determine the preference for seating. A reverse auction for an airline ticket may be parameterized using this context information, and this information may be maintained in the auction resource pool. Similarly, the buyer agent may track the buyer's game play timing and performance (and possibly the user's history of game play and performance), and a reverse auction for network bandwidth and game training may be parameterized and automatically executed based on this context information. Likewise, the buyer agent may track the buyer's wellness habits and schedule and may parameterize and execute reverse auctions for the wellness application in a similar fashion.

The dashboard 500 may limit the intrusiveness of the auction process to the normal operation of the user. The dashboard 500 may also be valuable in optimizing resource utilization and in providing a level of efficiency and convenience beyond what an individual auction system might offer. In some scenarios using the dashboard 500, specific needs of the user may be addressed at significantly less than average cost from the available sources.

The reverse auction system 200 may facilitate diverse compensation types. In many reverse action scenarios, users may find it difficult to participate in auctions. For instance, in an airport scenario, a passenger (buyer) may desire to take an earlier flight. Here, the airline may post this request, and several passengers (sellers) who hold the fares of the earlier flight may be willing to bid. However, if the compensation is only facilitated as airline credits and a later flight seat, some potential sellers may not be interested in this compensation and may not be likely to make seller bids for the posted request.

A similar situation may occur in game play scenarios. In an example scenario, a player (buyer) may post a request for another experienced player to assist with a mission. If the reverse auction system provides a plurality of different types of compensation, more players may be motivated for different reasons to participate in the reverse auction. For example, if only game points were available as compensation, an experienced player may not prefer to bid because they do not need extra game points, or because they prefer hard cash or other rare in-game resources that they may need. By facilitating compensation in diverse forms, such as different types of real or virtual currency, or different types of real or virtual goods, the reverse auction service may increase the number of potential sellers.

In an exemplary embodiment, the system may facilitate diverse types of compensation to be used for requests in order to encourage participation in the reverse auction. For example, in an airport scenario, a reverse auction service may compensate in a more diverse way, such as upgrading a class in a next flight, one night of a hotel stay, a ticket refund, or even a flight to different destination. As a result, more potential sellers may be interested in the compensation and be willing to make seller bids. The auction server may also provide the charges for such alternative compensation and service fees to the buyers, and may let the buyers decide whether to offer these alternative forms of compensation.

As another example mobile application and game scenario, the App/game server may provide rare virtual items or resources as compensation in addition to virtual currency, thus incentivizing more experienced players who are interested in these rare items to be more willing to bid. The auction server may provide estimated charges and service fees for these diverse compensations to buyers, and may let buyers decide which if any of these diverse types of compensation to offer. The decision process may include several factors besides a charge for requests. For example, the bids may include not only the estimated charges of the request, but also availability time, fulfillment quality and the like. An example of a request for bid format which includes additional attributes to define types and quantities of compensation may include:

```
Request-ID: R-XXX
{
    Bid-ID: B-XXX;
    Bid-Compensation: Resource-ID;
    Proposed unit of compensation: XXX;
    Availability: time;
    Fulfill quality: Excellent;
    Bidder rate: 4.5 out of 5 (52 rates);
    Bidder review: link to review;
    Estimated charge: $50;
    Service fee: $2;
}
```

Here, the request and bid are each identified with a handle/identifier. The proposed bid compensation is identified by a resource identifier. A proposed unit of compensation is provided, as well as parameters identifying minimum availability time, minimum quality, minimum bidder rating, estimated charge, and service fee.

In an example, the auction server may calculate estimated charges and service fees. In a further example, the service fees may not be charged by the sellers.

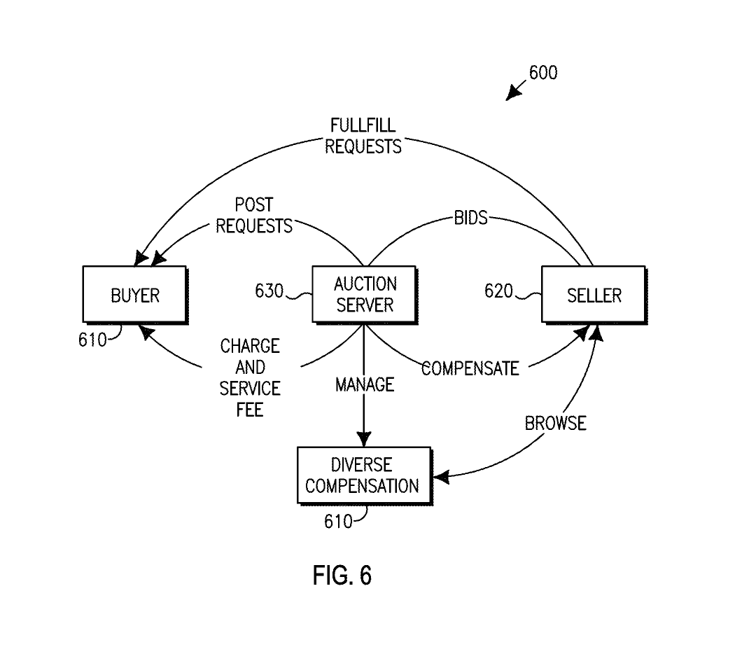

FIG. 6 is a diagram of an example process flow 600 of a reverse auction among a buyer 610, a seller 620, and an auction server 630. Auction server 630 may be substantially similar to auction service server 210, and may be implemented in a system substantially similar to reverse auction service system 200. Initially, the buyer 610 may post a request on the auction server 630. The auction server 630 then may complete this request by offering several diverse types of compensation 640 for the request. At this time, the sellers 620 may browse posted requests with their available compensation 640. Once the sellers 620 choose a request with a specific compensation category, they may bid the request by proposing amounts of a chosen compensation. At each bidding round, the auction server 630 may collect all of the bids and convert them to currency or a uniform price. In this way, different types of compensation 640 for bids may be compared together and be presented to buyer 610 who may use the presented bids to determine whether to accept any of the bids. The conversion rate may be set by an auction service provider (e.g., via auction server 630) based on a reasonable or currently established market price. For example, the price of a “rare game item” may be set based on an in-application store price. A “one night hotel stay” may be priced based on a special discount price from a hotel. At the final round of bidding, buyer 610 may select a desired bid. The auction server 630 may then charge buyer 610 currency or resources plus service fees. After the price of the compensation and service fee is charged, the winning seller may be allowed to fulfill the request for the buyer and to obtain the compensation from the auction server 630.

By organizing diverse compensation in this way, as more diverse types of compensation for an auction are provided, more potential buyers may be willing to participate in the auction and select from among diverse bids. For example, in a gaming context, a potential buyer may select to provide compensation in the form of a virtual special weapon and shield instead of a bonus or solution to a puzzle. An estimated charge may be calculated for each diverse compensation based bid (or ordinary compensation based bid) by the auction service server 210. The sum of the charge and service fee for each bid may be provided to buyer by the auction service server 210 in order to be chosen. On the other side, the buyer may pay the price asked by the auction service server 210 using currency or resources.

In a reverse auction market, an auction server may be configured to recommend auction requests to potential sellers and to recommend available items to potential buyers. The auction server may also or alternatively be configured to recommend compensation types to sellers. If diverse compensation types are applied to each auction request, each auction request's compensation categories may be suggested by buyers or may be generated by the auction server. In this way, each auction request may include or support different compensation categories. Even if two auction requests have the same content (e.g., the same requested goods and/or services), they may be configured to provide compensation in a different way. This compensation diversity may create opportunities for the auction server to make recommendations. For example, an experienced player may be interested in specific game resources or virtual items. As a result, the reverse auction server may recommend posted requests, which provide compensation in the form of these resources or virtual items to this experienced player. Auction requests thus may be recommended to potential sellers based on their preferences.

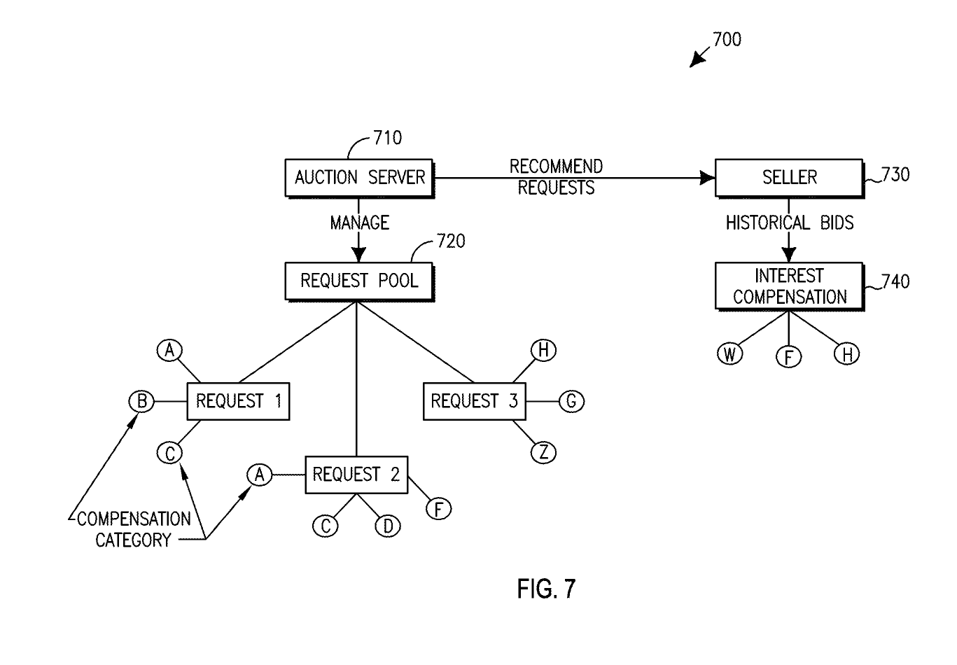

FIG. 7 is a diagram of an example process flow 700 illustrating example request recommendations in a reverse auction. An auction server 710 may manage a pool of requests 720, which offer different categories of compensation (e.g., A, B, C, D, F, G, H, W, Z). Each seller 730 may have a list of historical bids which provide an indication 740 of the seller's preference in compensation categories. Based on the type of compensation available for various requests and based on the historical bids of sellers, the auction server may thus recommend certain requests to certain sellers.

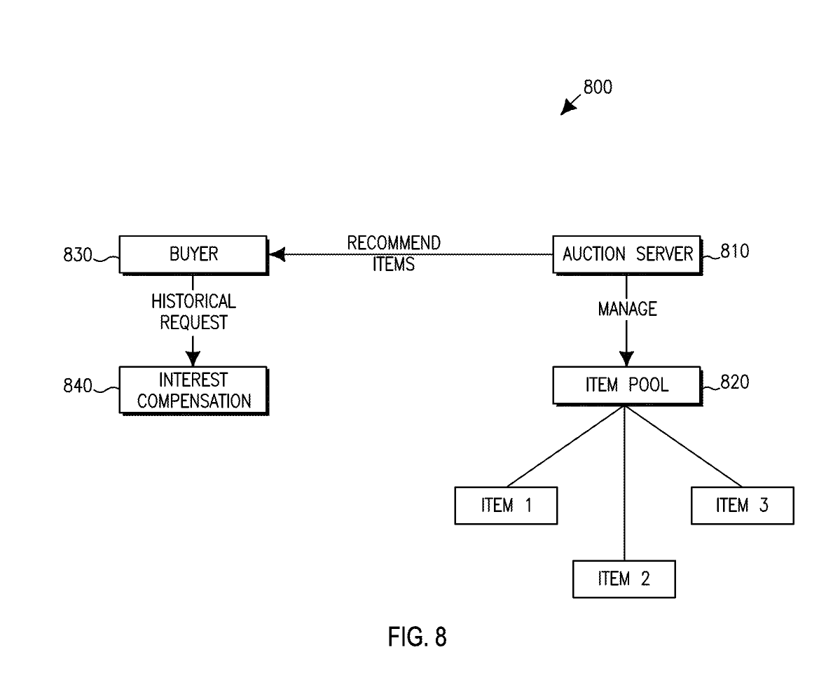

In a further example, the server may recommend compensation types to buyers. FIG. 8 is a diagram of an example process flow 800 illustrating example item recommendations to buyers in a reverse auction.

In order to coordinate resources when they are idle, an auction server 810 may allow potential sellers to post available resource items on the auction market in an item pool 820 and the auction server 810 may make recommendations of these available resources to potential buyers 830. For example, a resource, such as an experienced player, may be idle, and there may be no request for him in the market but there may in fact be a need for his help. The auction server 810 may thus recommend this resource (i.e., his available time) to other players. If any of the other players happen to have this need, that player (e.g., buyer 830) may create a request for a reverse auction for acquiring the help of the experienced player. In this way, there may be many available resource items in the market and potential buyers may be informed to create requests responsively. A benefit may be that idle resources may be distributed optimally and more requests for reverse auction may be motivated to be created. Sellers may post their available resources (e.g., Item 1, Item 2, Item 3) as items in an item pool 820 managed by auction server 810. Ordinarily, if a potential buyer 830 finds them interesting, buyer 830 may create a request to acquire this resource. Further, based on historical requests posted by buyers, the auction server 810 may infer an interest request 840 and may recommend available resources which match their interests.

As can be appreciated from the foregoing, an example auction service, which may be integrated with an application server, or which may be a third party service which may be for example provided on a third party server, may capture and/or accumulate context information regarding resources, buyers, and sellers in a pervasive network. Thus, the auction service may be considered to be context-aware. The auction service, or agent applications serving as proxies for potential buyers and sellers of resources via the auction service, may identify buying or selling opportunities automatically based on the captured or accumulated context, and may automatically execute reverse auction transactions based on this context and/or configuration parameters supplied by the potential buyers and sellers. The auction service may deal in real or virtual goods and services. It is noted that as used herein, the terms bid price, offer price, and sell price may be used interchangeably.

Although features and elements are described above in particular combinations, one of ordinary skill in the art will appreciate that each feature or element may be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method for managing and exchanging a resource utilized at a Wireless Transmit/Receive Unit (WTRU) within a communications network through a context based reverse auction, comprising:
receiving, by an auction service server, seller context information regarding at least one potential seller's WTRU;
receiving, by the auction service server, buyer context information regarding at least one potential buyer's WTRU;
receiving, by the auction service server, resource context information regarding at least one resource utilized at the at least one potential seller's WTRU or the at least one potential buyer's WTRU;
identifying, by a buyer agent application executing on the auction service server in real-time, a buying opportunity based on at least one of the seller context information, buyer context information, or resource context information;
automatically initiating, by the buyer agent application, a reverse auction of a resource based on the buying opportunity;
placing, by at least one seller agent application executing on the auction service server, at least one bid in the reverse auction, based on at least one of the seller context information, buyer context information, and resource context information; and
conducting a transaction of the at least one resource between the at least one potential buyer's WTRU and the at least one potential seller's WTRU based on the reverse auction.

2. The method of claim 1, further comprising weighting, by the auction service server, the at least one bid, based on at least one of the seller context information, buyer context information, or resource context information.

3. The method of claim of claim 1, wherein seller context information, buyer context information, or resource context information comprises information related to at least one of a location, proximity, availability, or quality.

4. (canceled)

5. The method of claim 1, wherein the reverse auction comprises calculating, by the auction service server, a mean of the at least one bid placed in a bidding round of the reverse auction;
on a condition that the mean differs by more than a threshold amount from a mean of an earlier bidding round of the reverse auction, initiating a subsequent bidding round of the reverse auction; and
on a condition that the mean does not differ by more than the threshold amount from the mean of the earlier bidding round of the reverse auction, concluding the reverse auction.

6. The method of claim 1, wherein the seller context information, buyer context information, or resource context information comprises application event data received by the auction service server from an application server.

7. The method of claim 1, further comprising calculating, by the auction service server, a standard deviation of the at least one bid; and
on a condition that a bid of the at least one bid is greater than or less than a mean of the at least one bid by the standard deviation, deleting that bid.

8. The method of claim 1, wherein the at least one resource comprises available network bandwidth at a small cell node utilized by the at least one potential seller WTRU and the at least one potential buyer WTRU within the communications network.

9. The method of claim 1, wherein the auction service server accumulates seller context information, buyer context information, or resource context information in real time over a pervasive network.

10. A system for managing and exchanging a resource utilized at a Wireless Transmit/Receive Unit (WTRU) within a communications network through a context based reverse auction, comprising:
an auction service server comprising a processor and a memory;
the auction service server comprising receiver circuitry configured to receive and store in the memory seller context information regarding at least one potential seller's WTRU;
the receiver circuitry further configured to receive and store in the memory buyer context information regarding at least one potential buyer's WTRU;
the receiver circuitry further configured to receive and store in the memory resource context information regarding at least one resource utilized at the at least one potential seller's WTRU or the at least one potential buyer's WTRU;
a buyer agent application executing on the processor;
the buyer agent application configured to identify a buying opportunity in real-time based on at least one of the seller context information, buyer context information, or resource context information stored in the memory;
the buyer agent application configured to automatically initiate execution of a reverse auction of a resource on the auction service server based on the buying opportunity;
a seller agent application configured to place at least one bid in the reverse auction based on at least one of the seller context information, buyer context information, and resource context information stored in the memory; and
the auction service server further configured to conduct a transaction of the at least one resource between the at least one potential buyer's WTRU and the at least one potential seller's WTRU based on the reverse auction.

11. The system of claim 10, further comprising weighting, by the auction service server, the at least one bid, based on at least one of the seller context information, buyer context information, or resource context information.

12. The system of claim 10, wherein seller context information, buyer context information, or resource context information comprises information relating to at least one of a location, proximity, availability, or quality.

13. (canceled)

14. The system of claim 10, wherein the reverse auction comprises
calculating, by the auction service server, a mean of the at least one bid placed in a bidding round of the reverse auction;
on a condition that the mean differs by more than a threshold amount from a mean of an earlier bidding round of the reverse auction, initiating a subsequent bidding round of the reverse auction; and
on a condition that the mean does not differ by more than the threshold amount from the mean of the earlier bidding round of the reverse auction, concluding the reverse auction.

15. The system of claim 10, wherein the seller context information, buyer context information, or resource context information comprises application event data received by the auction service server from an application server.

16. The system of claim 10, further comprising calculating, by the auction service server, a standard deviation of the at least one bid; and
on a condition that a bid of the at least one bid is greater than or less than a mean of the at least one bid by the standard deviation, deleting that bid.

17. The system of claim 10, wherein the at least one resource comprises available network bandwidth at a small cell node utilized by the at least one potential seller WTRU and the at least one potential buyer WTRU within the communications network.

18. The system of claim 10, wherein the auction service server accumulates seller context information, buyer context information, or resource context information in real time over a pervasive network.

19. A method for managing and exchanging a resource utilized at a Wireless Transmit/Receive Unit (WTRU) within a communications network through a context based reverse auction, comprising:
receiving, by an auction service server, seller context information regarding at least one potential seller's WTRU;
receiving, by the auction service server, buyer context information regarding at least one potential buyer's WTRU;
receiving, by the auction service server, resource context information regarding at least one resource utilized at the at least one potential seller's WTRU or the at least one potential buyer's WTRU;
identifying, by a seller agent application executing on the auction service server in real-time, a selling opportunity based on at least one of the seller context information, buyer context information, or resource context information;
automatically initiating, by the seller agent application, a reverse auction of a resource based on the selling opportunity;
placing, by the buyer agent application, at least one bid in the reverse auction, based on at least one of the seller context information, buyer context information, and resource context information; and
conducting a transaction of the at least one resource between the at least one potential buyer's WTRU and the at least one potential seller's WTRU based on the reverse auction.

20. The method of claim 19, wherein the reverse auction is initiated automatically based on at least one of the seller context information, buyer context information, or resource context information.
